(19) United States
(12) Patent Application Publication
(10) Pub. No.: US 2003/0215371 A1
(43) Pub. Date: Nov. 20, 2003

(54) Chemical-physical reactions displaced by pressure

(76) Inventor: Gines Sanchez Gomez, Mostoles (ES)

Correspondence Address: Gines Sanchez Gomez, Calle Cervantes, 1, 7°, B, Mostoles (Madrid), 28932, ES

(21) Appl. No.: 10/434,926

(22) Filed: May 8, 2003

(30) Foreign Application Priority Data
May 18, 2002 (ES) P200201138

(51) Int. Cl. B32B 27/02

(52) U.S. Cl. 422/168

(57) ABSTRACT

A system for chemical-physical reactions comprising a reaction chamber, being the reaction products in gas phase, followed by several condenser where the products are recovered according their vaporization temperature. Said products are moved by differences of pressure between two consecutive devices. In each device the products are entered through a pump/turbine and recovered through a turbine/pump, being linked all the shafts of said pumps and turbines so that the turbines and pumps are moved by only one motor.

### CROSS-REFERENCE TO RELATED APPLICATIONS

The present invention is based on the Spanish application of patent no. P200201138, dated May 18, 2002, that is priority. Following patents are related with the present invention:

U.S. Pat. No. 4,400,184 of Tomita et al., priority date May 18, 1979, about a system for recovering as power the pressure and sensible heat of the gas discharged from the top of a blast furnace,

U.S. Pat. No. 4,917,710 of Haruna et al., priority date Mar. 17 1988, about a process for recovering an oxygen enriched gas from a mixed gas mainly composed of nitrogen gas and oxygen gas.

### BRIEF SUMMARY OF THE INVENTION

A lot of system for obtaing ammonia are based in displacing the reaction by increasing the work pressure.

Similarly, it is possible to displace the reactions type

iA+jB→kC+lD,

volume iA+jB<>volume kC+lD

j or l could be zero, having in this case the following reactions:

iA+jB→kC

iA→kC+lD

In this system, the products A, B, C, D and their polluting agents are coexisting at the same time.

But the ammonia is easy to separate from the rest of the products because the ammonia are very easy to dissolve in water, and not the hydrogen or the nitrogen.

But in the general case, it is possible to separate the products in gas phase by consecutive distillation phases.

So, it is possible to arrange a reaction chamber, followed by several condensers to different pressures.

When the pressure of the reaction chamber is lower 1 at., this pressure helps/opposites to enter/exit of the products. When the pressure of the reaction chamber is upper 1 at., this pressure helps/opposites to the exit/enter of the products.

The product steams which are helped by the pressure differences are drove through turbines while the product steams which are opposed to the pressure differences are drove through pumps, being linked all the shafts of said pumps and turbines so that the turbines and pump are moved by only one motor or braked by only a brake. So, a work compensation is obtained.

In addition, the relative volume between the turbines and the pumps is the same that its connected products, so, the system also controls the proportion of the products.

Regarding this invention, a turbine is a device which transforms pressure differences in mechanical energy and a pump is a device which transforms mechanical energy in pressure differences. There are a lot of turbine and pump types, but the set of turbine—pump—common shaft—motor shaft—motor or brake must be compatible. So, they are possible the following configurations:

a rotating turbine, a rotating pump, a rotating common shaft, a rotating motor shaft and a rotating motor,

a piston turbine, a piston pump, a oscillation common shaft, a rod-crank mechanism and a rotating motor,

a rotating turbine, a rotating pump, a rotating common shaft, a rod-crank mechanism and a piston motor,

a piston turbine, a rotating pump, the common shaft being a rod-crank mechanism, a rotating motor shaft and a rotating motor,

Finally they are possible the following two cases:

=iA+jB→kC+lD, volume iA+jB>volume kC+lD, helped by pressures>1 at.

=iA+jB→kC+lD, volume iA+jB<volume kC+lD, helped by pressures<1 at.

### BRIEF DESCRIPTION OF THE FIGURES

FIG. 1. A system for chemical-physical reactions type iA+jB→kC+lD, volume iA+jB>volume kC+lD.

FIG. 2. A system for chemical-physical reactions type iA+jB>kC+lD, volume iA+jB<volume kC+lD.

FIG. 3. The system for chemical-physical reactions type iA+jB←kC+lD, volume iA+jB>volume kC+lD, when C, D or any polluting agent are liquates in the reaction chamber.

FIG. 4. The system for chemical-physical reactions type iA+jB←kC+lD, volume iA+jB<volume kC+lD when C, D or any polluting agent are liquates in the reaction chamber.

FIG. 5. To obtain O3S from O2S+dry air.

### DETAILED DESCRIPTION OF THE INVENTION

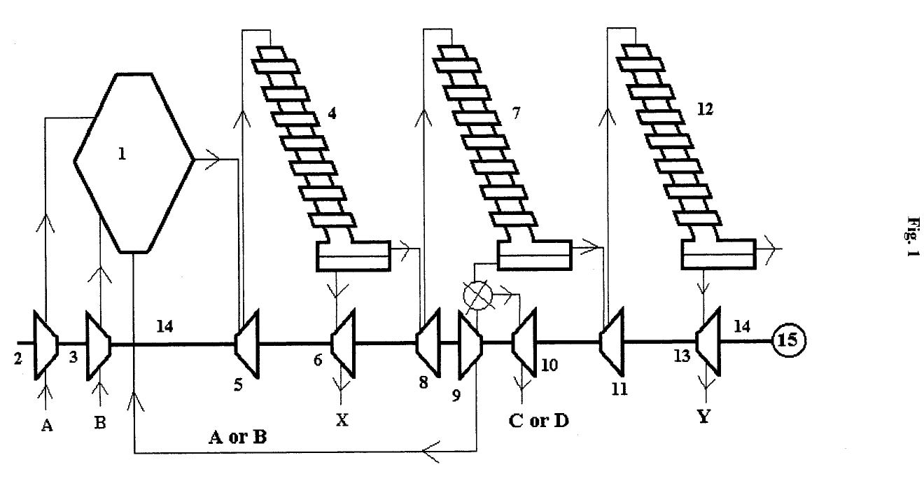

FIG. 1 In addition to the products A, B, C and D of the reaction iA+jB←→kC, i+j<>k, the system has polluting agents from A, B or not desired products from the process. Being t1>t2>t3>t4 the boiling points of A, B, C and D (not respectively), said boiling points determine the following seven ranges of temperature (t)

t<t1, products X (polluting agents),

t=t1,

t1<t<t2, products Y (polluting agents),

t=t2,

t2<t<t3, products Z (polluting agents),

t=t3,

t3<t<t4, products XX (polluting agents),

t=t4,

t>t4, products YY (polluting agents).

Case iA+jB→kC+lD, volume iA+jB>volume kC+lD (ammonia reaction when l=0), helped by pressures>1 at.

The system comprising a reaction chamber 1, said chamber being similar to the ammonia chamber, a furnace to burn A and B, or a container. The temperature of the chamber is to maintaining the products A, B, C and D in gas phase and an accurate velocity of reaction. Into the chamber it would be a catalyst. The pressure of the reaction chamber is the upper of the system.

A and B are respectively entered through a first pump 2 and a second pump 3. Their associated polluting agents are also entered.

The products A, B, C, D, X, Y, Z, XX and YY are entered to a first condenser 4 through a first turbine 5. This first condenser liquates the products X, being recovered from the system through a second turbine 6.

The rest of products are entered to a second condenser 7 through a second turbine 8. This condenser liquates A, B C or D.

If A or B (liquid phase), this product is injected to the reaction chamber through a third pump 9. If C or D, this product is recovered from the system through a fourth turbine 10.

The rest of products are entered to a third condenser 12 through a fifth turbine 13. This condenser liquates Y, being recovered from the system through a sixth turbine 13.

So successively.

All the shafts of all the turbines and pumps 14 are linked, so that only a motor o brake 15 moves/brakes the set of said devices. In addition, the relative volume between the turbines and the pumps is the same that its connected products.

The condensers could also be distillation system.

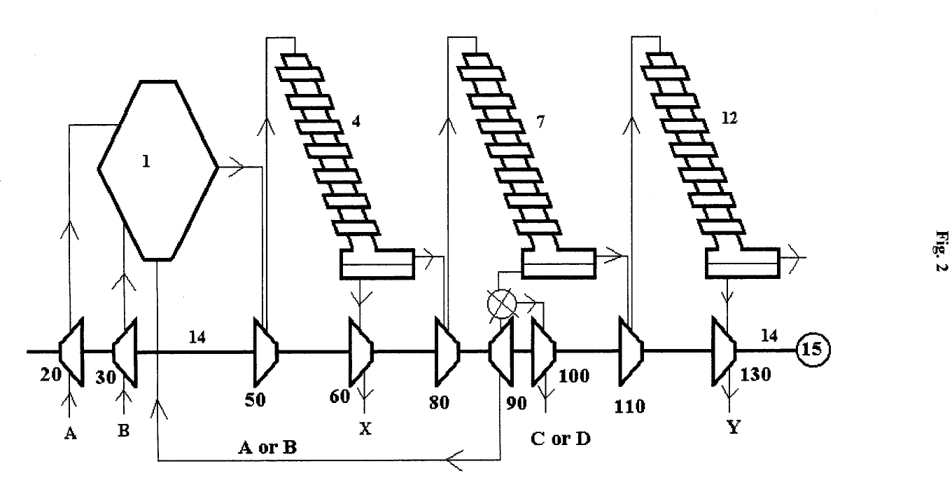

FIG. 2. Case iA+jB→kC+lD, volume iA+jB<volume kC+lD, helped by pressures<1. The structure of the system is the same the FIG. 1, with the following changes:

the pressure of the reaction chamber is the lower of the system,

the pump are changed by turbines and the turbines are changed by pump.

So the symbols 20, 30, 90 are turbines and the symbols 50, 60, 80, 100, 110 and 130 are pumps.

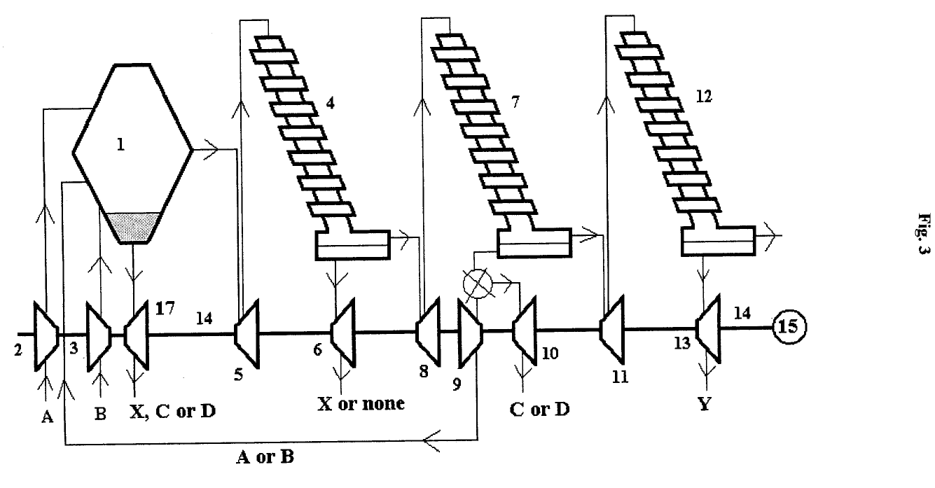

FIG. 3. The case of the FIG. 1 but the temperature of the reaction chamber is to maintaining the products A, B, C and D in gas phase, excepted only one of C or D or X wich is liquid. In this case a new turbine 17 is added to directly recover the liquid product from the reaction chamber.

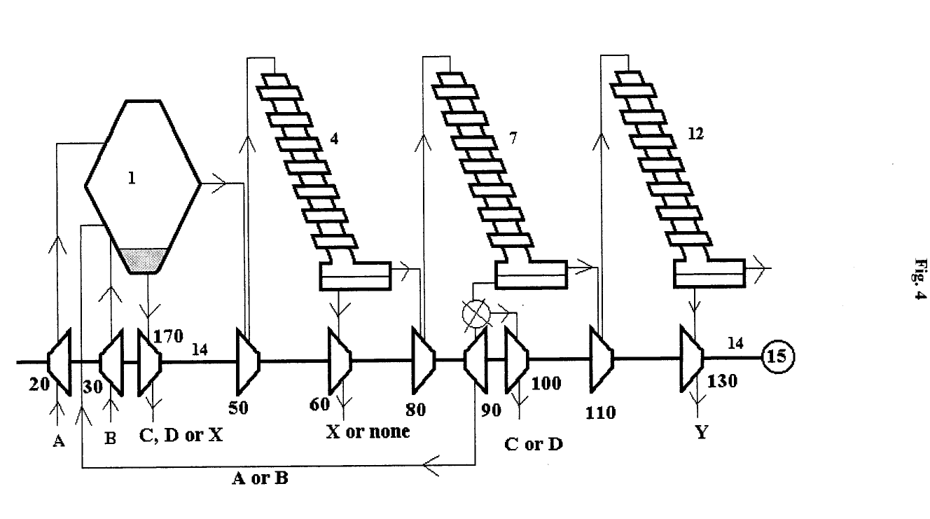

FIG. 4. The case of the FIG. 2 but the temperature of the reaction chamber is to maintaining the products A, B, C and D in gas phase, excepted only one of C or D or X wich is liquid. In this case a new pump 170 is added to directly recover the liquid product from the reaction chamber.

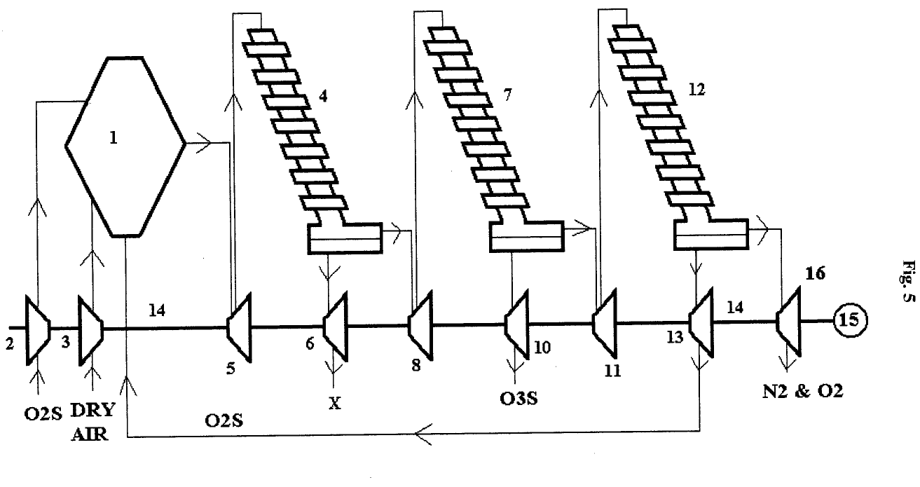

FIG. 5. To obtain O3S from O2S+dry air. The reaction is

O2S+½O2→O3S,

being X and the N2 the polluting agents.

The difference with the FIG. 1 is which the remained O2 is not recovered from the mixture of N2+O2 because the O2 is very difficult to liquate. Said mixture would go to the atmosphere through the turbine 16. This mixture is abundant in N2 regarding the air.

I claim for:

1. A method for chemical-physical reactions displaced by pressure, said reactions having place in one o several containers or devices, each container or device having a work pressure, characterized in that all transport of products between containers, devices and the exterior are performed at the same time, by compensating all the pressure differences between containers, devices or exterior.

2. The method of the claim 1 for making chemical reactions type iA+jB→kC+lD, volume iA+jB<>volume kC+lD, characterized in that
the reaction is performed at a pressure to displace the reaction in the accurate sense,
the reaction products and their polluting agents are separated by condensation or by distillation,
the initial reaction products are reused,
the final reaction products and the polluting agents are recovered.

3. A system for chemical-physical reactions displaced by pressure, said reactions having place in one o several containers or devices, each container or device having a work pressure, characterized in that the transport of products between containers, devices and the exterior are performed through pumps/turbines according that each pressure difference opposites/helps each transport, being linked all the shafts of said pumps and turbines so that the turbines and pump are moved by only a motor or braked by only a brake, being the relative volume of the turbines and the pumps the same which their connected products.

4. The system of the claim 3 for making up chemical reactions type iA+jB→kC+lD, volume iA+jB<>volume kC+lD, comprising
a reaction chamber being similar an ammonia chamber, a furnace or a container,
a pressure in said chamber to displace the reaction in the accurate sense,
consecutively one or several condenser of distillation systems,
feed links between the exterior and the reaction chamber,
condenser links between two consecutive condensers in gas phase,
return links between each condenser and the reaction chamber in liquid phase,
exit links between each condenser and the exterior.

5. The system of the claim 4 for making up the reaction O2S+½O2→O3S obtaining the O2 from the atmospheric air characterized in that the polluting agents from the O2S are recovered in the first condenser, the O3S is recovered in the second condenser, the O2S is recovered in the third condenser being returned to the reaction chamber and the N2 and the remaining O2 are recovered directly in gas phase.
